(19) United States
(12) Patent Application Publication
(10) Pub. No.: US 2006/0229900 A1
(43) Pub. Date: Oct. 12, 2006

(54) System and method for managing real estate investments

(76) Inventors: Marc J. Paul, Beverly Hills, CA (US); Douglas E. Johnston JR., Santa Monica, CA (US)

Correspondence Address: GREENBERG TRAURIG LLP, 2450 COLORADO AVENUE, SUITE 400E, SANTA MONICA, CA, 90404, US

(21) Appl. No.: 11/205,511

(22) Filed: Aug. 16, 2005

Related U.S. Application Data
(60) Provisional application No. 60/669,065, filed on Apr. 6, 2005.

(51) Int. Cl. G06Q 99/00

(52) U.S. Cl. 705/1

(57) ABSTRACT

A data processing method and system of selling tenant-in-common interests as non-security investments by a real estate sponsor is disclosed. A real estate property is purchased at a purchase price. An investment price of a tenant-in-common interest in the real estate property is calculated by a computer system utilizing the purchase price and a sponsoring fee. The real estate sponsor then solicits at least one offer to purchase a tenant-in-common interest in the real estate property at least through a computer network. At least one offer to purchase a tenant-in-common interest in the real estate property is received by the real estate sponsor. The real estate sponsor then accepts an offer to purchase a tenant-in-common interest from at least one investor. All control on the real estate property is divested from the real estate sponsor. Thus, day-to-day property management is yielded to a third party, such that the real estate sponsor relinquishes all right to exercise property management control, the third party being elected by the at least one investor. The real estate sponsor and the at least one investor close the sale of the real estate property.

This application claims the benefit of the prior filing date of U.S. provisional patent application No. 60/669,065, filed Apr. 6, 2005, herein incorporated by reference in its entirety.

### BACKGROUND OF THE DISCLOSURE

1. Field of the Disclosure

The present disclosure relates to a data processing system and method. In particular, it relates to a data processing system and method for managing real estate investments.

2. General Background

With the advent of recent regulations promulgated by the Internal Revenue Service (IRS), existing Section 1031 tax deferment benefits have been expanded to cover a broader range of qualifying tenant-in-common transactions. New systems and methods have been developed to take advantage of such deferments. In particular, tenant-in-common transactions have become more prevalent in the real estate marketplace. With the investor holding direct title via a grant deed, major institutional lenders, law firms and tax accounting firms have now embraced this additional tenant-in-common venue for structuring tax-advantaged like-kind exchange commercial property transactions. However, current systems and methods have failed to take full advantage of tenant-in-common transactions and investment structures.

### SUMMARY

In one aspect, there is a data processing method of selling tenant-in-common interests as non-security investments by a real estate sponsor. A real estate property is purchased at a purchase price. An investment price of a tenant-in-common interest in the real estate property is calculated by a computer system utilizing the purchase price and a sponsoring fee. At least one offer to purchase a tenant-in-common interest is solicited in the real estate property at least through a computer network. At least one offer to purchase a tenant-in-common interest in the real estate property is received by the real estate sponsor. An offer to purchase a tenant-in-common interest from at least one investor is accepted. Further, day-to-day property management control is yielded to a third party, such that the real estate sponsor relinquishes all right to exercise property management control, the third party being elected by the at least one investor. The at least one investor closes the sale with the real estate sponsor.

In another aspect, the at least one offer is solicited based on the calculated investment price. The calculated investment price does not take into account any securities brokerage fees. The sponsoring fee can comprise a loan brokerage commission. The real estate sponsor can collect the sponsoring fee from proceeds of the sale of the properties. The real estate sponsor can secure a mortgage loan and a preferred loan, the preferred loan being paid with proceeds of tenant-in-common interest sale to the at least one investor.

In another aspect, investor data related to investors that submitted offers is stored in an investor database. The investor database can reside in a mass storage server. Furthermore, day-to-day property management can be yielded to a third party by transferring management privileges of the investor database from the real estate sponsor to the third party. The third party can be an asset manager, property manager, administrator, or trustee. Furthermore, the third party is a property manager, the property manager being able to postulate himself for election by the at least one investor through a real estate sponsor website. The real estate sponsor can be an investor. For this end, the real estate sponsor can purchase a tenant-in-common interest in the real estate property.

In yet another aspect, soliciting at least one offer to purchase a tenant-in-common interest includes requiring the investors to provide statements of prior experience in owning and operating developed real estate and of willingness to exercises control of ownership rights on the tenancy-in-common interest. Furthermore, soliciting at least one offer to purchase a tenant-in-common interest can also include advertising on a public medium, including price, interest rates, physical condition of the property, property management agreement, and asset management agreement. A real estate broker can be utilized to advertise the tenant-in-common interests.

The period lapsed between purchasing the real estate property and closing the sale of the real estate property can be less than forty-five days such that the real estate sponsor can benefit from tax deferments.

The computer system can be connected to the computer network, and the computer system is configured as a web server that displays the calculated investment price on a website. An offer can be made by submitting investor information and offer information to a server administrated by the real estate sponsor.

In another aspect, the data processing method of selling tenant-in-common interests as non-security investments by a real estate sponsor can further include transferring asset management duties to an asset manager. The asset manager can guide and assist in the decision whether to retain the same third party to conduct day-to-day property management or to elect another party in order to conduct day-to-day property management. The at least one investor can choose between ratifying the election of the asset manager and declining the election of the asset manager.

In yet another aspect, the data processing method of selling tenant-in-common interests as non-security investments by a real estate sponsor can further include receiving a second offer to purchase a tenant-in-common interest in the real estate property. The second offer is accepted. The second offer can be from at least one investor. Finally, the real estate sponsor and the at least one investor close the sale.

In one aspect, there is a method of selling tenant-in-common interests as non-security investments by a real estate sponsor. A real estate property is purchased at a purchase price. An investment price of a tenant-in-common interest in the real estate property is calculated based on the purchase price and a sponsoring fee. At least one offer to purchase a tenant-in-common interest is solicited in the real estate property. At least one offer to purchase a tenant-in-common interest in the real estate property is received. Then, an offer to purchase a tenant-in-common interest from at least one investor is accepted.

The day-to-day property management is yielded to a third party is such that the real estate sponsor relinquishes all right to exercise property management control, the third party being elected by the at least one investor. Lastly, the real estate sponsor closes the sale of the real estate property with the at least one investor.

In another aspect, there is a method of selling tenant-in-common interests as non-security investments by a real estate sponsor wherein the real estate sponsor secures a real estate property at a purchase price by committing to purchase the real estate property and obtaining a loan from a lender. After soliciting offers and accepting investment offers from investors, the sale of the property is closed between the lender and the at least one investor.

In one aspect, there is a method of selling tenant-in-common interests as non-security investments by a real estate sponsor. At least one tenant-in-common interest in a real estate property is offered to the public. An acceptance from at least one investor is received. The day-to-day property management is yielded to a third party, the third party being elected by the at least one investor. Thereafter, the real estate sponsor and the at least one investor close the sale.

### BRIEF DESCRIPTION OF THE DRAWINGS

FIG. 1 illustrates a component diagram of a data processing system for real estate control management.

FIG. 2 illustrates a business process diagram in a real estate control management system.

FIG. 3A illustrates flow diagram of the establishing of a real estate tenant-in-common investment structure where the real estate sponsor purchases investment property.

FIG. 3B illustrates flow diagram of the establishing of a real estate tenant-in-common investment structure where the real estate sponsor secures investment property.

FIG. 4 illustrates flow diagram of post-closing transactions.

FIG. 5 illustrates comparison chart among a real estate sponsor equity load, and a securities-type broker equity load.

### DETAILED DESCRIPTION

The system and method disclosed herein permit a real estate sponsor to offer tenancy-in-common interests that are non-securities real estate interests. Such non-security real estate structure allows the real estate sponsor to pay referral fees to real estate brokers and to advertise pending deals-in-process. Furthermore, unlike in any previous systems, all post-closing control of the property is transferred to the investors removing the real estate sponsor from any control position and thereby rendering the real estate sponsor free to act as an investor. Administrative responsibilities can be delegated to a third party. Thus, a real estate sponsor that invests in the property is not ethically conflicted as a co-investor because the real estate sponsor does not provide administrative functions (e.g. asset management, property management).

In one embodiment, the real estate sponsor controls the investment process through a computerized data processing system. The real estate sponsor can manage the flow of information and control during the contract forming period and the executory period. The asset manager can later maintain a website for day-to-day management and reporting to investors.

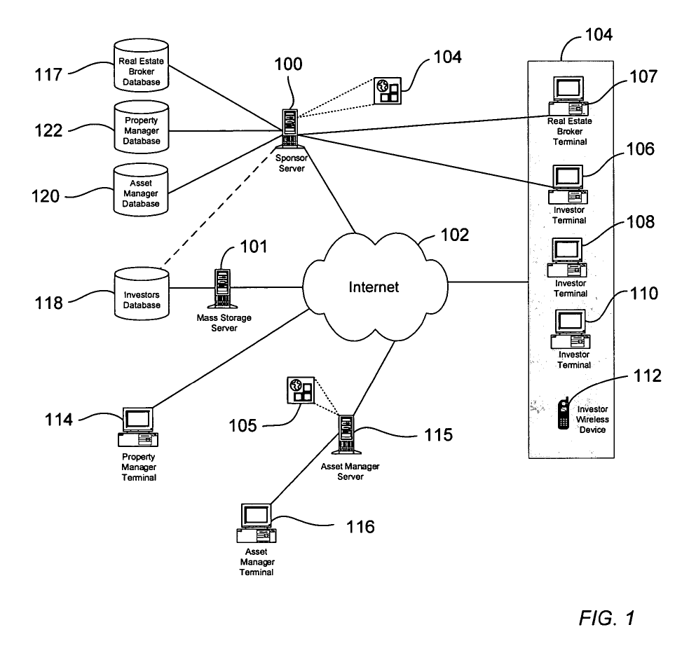

FIG. 1 illustrates a component diagram of a data processing system for real estate control management. In one embodiment, a sponsor server 100 provides web server functionalities and serves a website 103 posted in the Internet 102. The sponsor server 100 has full access to an asset manager database 120, a property manager database 122, and a real estate database 117. The sponsor server 100 can also have indirect access to an investors database 118 through a mass storage server 101.

The asset manager database 118 can be in electronic form such that data is stored in computer files, and managed by a database engine. In another approach, the asset manager database 118 can be a set of records that is non-electronic such as in paper form.

If the asset manager database 118 is in electronic form, the sponsor server 100 can populate data on the asset manager database 120 by storing in the asset manager database 120 information received through the website 103. Multiple asset managers can log in to the website 103 in sponsor server 100 through a computer terminal 116. The computer terminal 116 can connect to the Internet 102 through an asset manager server 115. In one approach, the website 103 is a secure website 103 that requires personal identification in the registration process so that only identified parties can read and post information on the website 103. The information offered to the asset managers through the computer terminal 116 can be limited to data that concerns the real estate property and not information related to investors.

The asset managers can provide their professional information and qualifications, background, experience, profile, etc., by posting such information on the website 103 at the sponsor server 100. Once this information is received by the sponsor server 100, the sponsor server 100 can add this information of the asset manager database 120. Likewise, the sponsor server 100 can publish information on the website 103 regarding asset managers' profiles, professional information and background along with any other information that the asset manager previously consented to disclose. This information is available and can be viewed by predetermined users that have been provided privileges to access that information.

Likewise, the property manager database 122 can also be populated through the website 103 that sponsor server 100 publishes on the Internet 102. At least one property manager can access the website 103 through a terminal 114 and can enter the profile information, qualifications, etc. Similar to the asset manager information, the property manager information collected by website 103 forms is stored in the property manager database 122. The property manager database 122 can be accessed later by the sponsor server 100 and be used to publish the property manager information on the Internet 102. The posted information is only published on a secure site where investors can access and make decisions and selections based on the profiles of property managers and asset managers.

The sponsor server 100 can connect to an investor's database 118. The investor database 118 can be accessible through a separate network server 101. In another embodiment, the investor database 118 resides connected directly to the sponsor server 100. The investor database 118 can be populated by receiving information through the secure website 103 where investors can access and include their profile information and investment backgrounds.

In one embodiment, the investor database 118 can be accessible through a separate network server 101. The investors can access the sponsor server 100 and be redirected to the mass storage server 101 wherein the investors enter their information. The investor information is added to the investors database 118 connected to the mass storage server 101. The sponsor server 100 can have privileges to edit, delete, and process investor information through the mass storage server 101. Once control of the management duties are passed to the asset manager, the asset manager receives full control and access to the investors database 118. Further, the sponsor server 100 will no longer be able to access any information in the investors database 118. In one approach, the real state sponsor 100 passes access and control of investor information to the asset manager by providing username and password to authenticate access to the investors database 118 through the mass storage server 101. In another approach, the real estate sponsor 100 can download a copy of the investors database 118 before control and access is tendered to the asset manager.

In another embodiment, the investor database 118 resides connected directly to the sponsor server 100. The investors can access directly the sponsor server 100 through an intranet such that the sponsor server 100 permits dial-up or other networking mechanism that does not require Internet 102 and permits direct secure connectivity with the sponsor server 100. Alternatively, the investors log in to the website 103 and have access to sponsor server 100 information to the extent that access privileges were conferred at registration. In general, investors can have read-only privileges regarding asset managers and property managers. Thus, each of the investors 104 can access the information on asset managers and property managers such that the investors can make an educated and informed decision when electing or selecting property managers and asset managers.

Investor information stored in the investors database 118 can be transferred to the asset manager when transferring other asset management duties. In one embodiment, the information can be transferred from the sponsor server 100 to the asset manager server 115 utilizing a file transfer protocol (FTP). The real estate sponsor can place an investor information file on an FTP server application, and the asset manager can download the investor information file onto the asset manager server 115. The asset manager server 115 can then publish a website 105 that includes information about the property, co-tenants, asset manager information, property manager information, etc.

An investor can be connected to the sponsor server 100 through a computer terminal 108 or computer terminal 110. Alternatively, the investor can also be connected to the Internet 102 and to the sponsor server 100 through a wireless device 112. Likewise, an investor can be an affiliate of a sponsor and be connected directly to the sponsor server 100.

A real estate broker terminal 107 is provided to one or more real estate brokers employed or contracted by the real estate sponsor to sell tenancy-in-common interests. The real estate broker terminal 107 enables a real estate broker to access property information, asset manager information, and property manager information. This information is useful to the real estate broker for selling tenancy-in-common interests in the property.

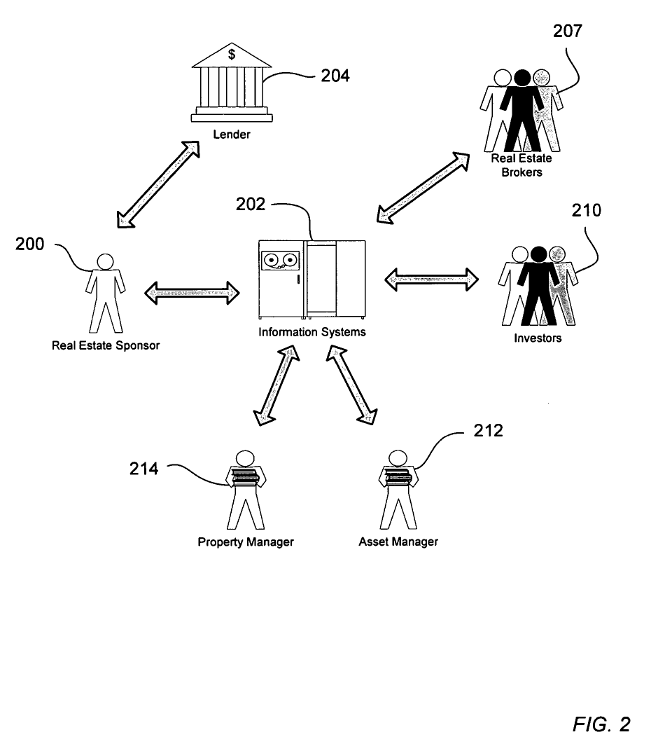

FIG. 2 illustrates a business process diagram in a real estate control management system. A sponsor 200 can communicate and deal with lender 204 to request a loan, negotiate interest rates, etc. The lender is not affiliated with real estate sponsor 200.

In like manner, the real estate sponsor 200 can communicate and deal with investors 210. The real estate sponsor 200 invites potential investors to make an offer. In one embodiment, the real estate sponsor 200 accepts offers from at most thirty-five investors. Investors 210 can generally be individuals that have hands-on experience in owning and operating developed income-producing real estate, and are aware of and intend to exercise their control rights in the transaction.

In one embodiment, the real estate sponsor 200 utilizes information systems 202 to communicate with investors 210 and with property manager 214 and asset manager 212. Investors 210 can also have access through the information systems 202 to property manager 214 and asset manager 212 information. Furthermore, investors 210 also communicate with real estate brokers 207 when purchasing a tenancy-in-common interest. The real estate brokers 207 have access to the information systems 202 to request data regarding the property in order to convey such information to the investors 210.

The property manager 214 and asset manager 212 can access information systems 202 and communicate with sponsor 200 or investors 210 so that a property manager 214 or an asset manager 212 can postulate himself as a candidate. Asset manager 212 and property manager 214 can communicate electronically or through any other medium with sponsor 200 and investor 210.

A property manager 214 can serve functions such as operate, lease and manage the day-to-day operations of the property, including: collecting rents on behalf of the investors 210; ensuring that cash flow from the property is paid over to the lender 204 on behalf of the investors 210 as required for the payment of principal, interest on and establishment of required reserves and escrows under the loan; distributing available cash flow after debt service, reserves, escrows and other expenses to the investors 210 on a pro-rata basis; maintaining the property in good condition; addressing tenant concerns or demands; ensuring tenant compliance with their lease obligations; and preparing an annual budget for the property with an estimate of revenues, costs and expenses.

The asset manager 212 can serve functions such as overseeing the property manager 214, studying market trends, advising on financial decisions. As such, the asset manager 214 can generally oversee the economic performance of the property and the activities of the property manager, including: reviewing the economic performance of the property; overseeing and engaging leasing agents as necessary to fill any vacancy occurring during the term of the property manager 214; ensuring that insurance is procured and maintained on the property; providing quarterly reports to the investors 210, including a narrative identifying collections, delinquencies, uncollectible items, vacancies and other matters pertaining to the management, operation and maintenance of the property during the prior quarter; providing notices to the investors 210; and maintaining the website 105 for the investors 210.

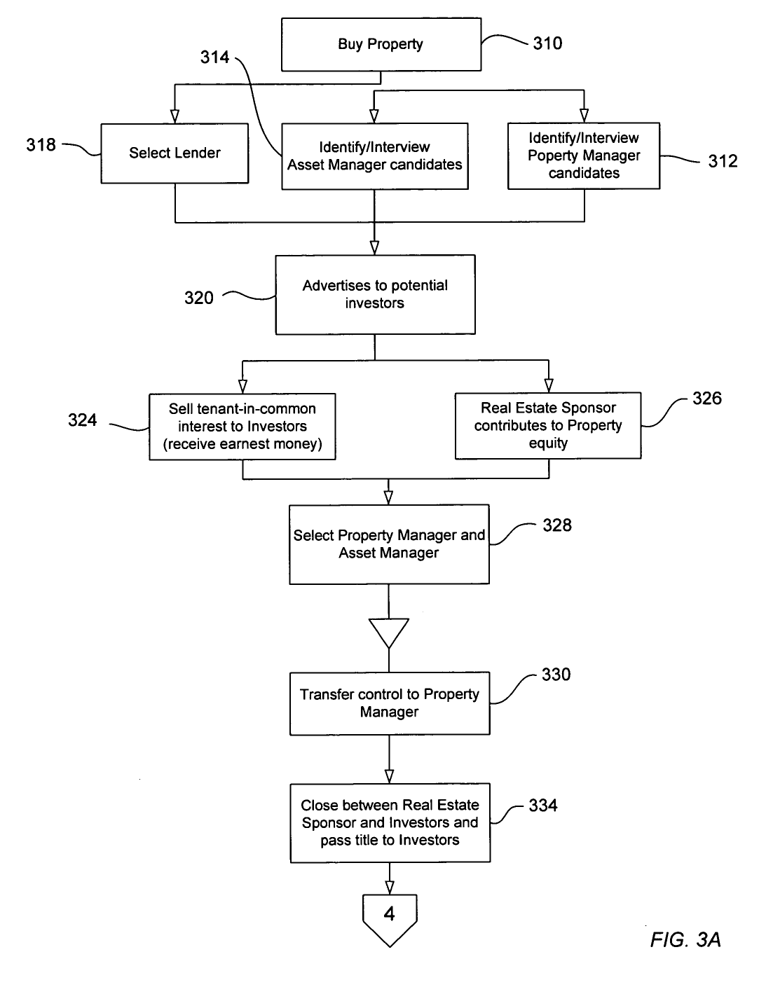

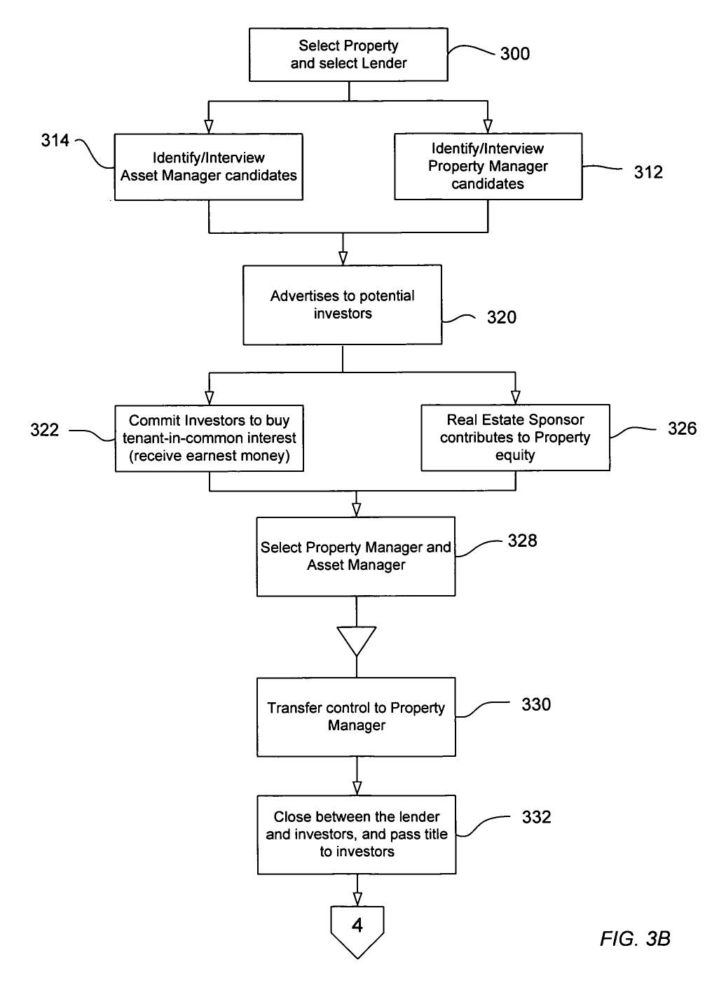

FIG. 3A illustrates flow diagram of the establishing of a real estate tenant-in-common investment structure where the real estate sponsor purchases an investment property. At process block 310, a real estate sponsor identifies the target property that can be offered to investors. In one embodiment, the target property is a cash-flowing ‘Class A’ like-kind exchange replacement property. The real estate sponsor 200 negotiates the price and purchases the property at its own expense and before any potential investor is identified.

Next, in process block 316, the real estate sponsor 200 identifies and selects the institutional lender 204. In one embodiment, the real estate sponsor 200 pre-negotiates with the lender 204 the long-term debt financing (i.e. the mortgage loan) for approximately sixty-five to seventy percent of the purchase price, and the mezzanine debt (i.e. the preferred loan) for approximately twenty-five percent of the purchase price.

The preferred loan can be projected to be paid off within a specified period after the initial close (e.g. nine months). The real estate sponsor 200 can elect to pay the preferred loan with proceeds originating from the sale of tenant-in-common interests on the property. The real estate sponsor 200 can further elect to make interest rate lock deposits. These interest rate lock deposits can ultimately benefits the investor 210 purchasing a tenant-in-common interest of the property.

The real estate sponsor 200 can use the proceeds of the sale of the tenant-in-common interests to repay the preferred loan, to pay expenses and fees (including those payable to the real estate sponsor 200 and affiliates) associated with the offering and to establish certain reserves.

At process block 314, the real estate sponsor 200 establishes asset manager candidates. The real estate sponsor 200 can release request for proposals to known asset managers. In one embodiment, the real estate sponsor 200 can post the request for proposals on the website 103 supported by sponsor server 100. Multiple asset manager candidates can then reply by communicating through telephone, email or posting their information and professional qualifications on the website 103. The real estate sponsor 200 can identify asset managers with high credentials, conduct interviews and negotiate compensation rates. Likewise, at process block 312, the real estate sponsor 200 makes a preliminary screening property manager candidates. The investors 210 can then vote or select the property manager 214.

At process block 320, the data processing system advertises to and identifies individuals to become investors 210. By way of background, investors 210 face the loss of related tax deferment advantages if their 1031 exchanges are not completed within the strict 45/180 day IRS deadlines. Given the short forty-five-day nomination timeline requirements set by the IRS for tax deferral eligibility by exchange investors, effective advertisement expedites the sale process. However, advertisement of deals in progress is not available for securities-type tenant-in-common interests. Most systems treat tenant in common interests as securities, and therefore have to adhere to Securities Exchange Commission (SEC) regulations.

In one embodiment, the data processing system and method can advertise the tenant-in-common interests as non-securities. Tenancy-in-common interests that are non-securities real estate can be advertised as deals-in-process without conflicting with securities regulation. The disclosed system can advertise the tenant-in-common product before the sale of the interests is closed.

The ability to advertise specific deals-in-process generates a competitive advantage for the sponsor 200 because investors 210 can receive information regarding the tenant-in-common as soon as the specific tenant-in-common interests are for sale. The ability to advertise with enough time in advance allows the real estate sponsor 200 has time to sell all the tenant-in-common interests before the forty-five-day IRS deadline. In addition, the investors 210 will also have more time to identify and nominate their replacement exchange properties within the 45-day nomination period.

Non-security tenancy-in-common interests can further be sold through real estate agents, thus saving the investor 210 added securities broker-dealer fees that would otherwise be charged if the tenancy-in-common interests were treated as securities. The sponsor 200 can have licensed in-house real estate brokers prepared to explain real estate investments to investors 210.

In one embodiment, potential investors are provided with all the disclosure information on-line. After registering with the sponsor server 100, the potential investor can log into a secure website 103 published at the sponsor server 100 and review the property information, physical condition of the property, interactive simulated viewing of the property, etc. In another embodiment, potential investors are provided with a comprehensive full-disclosure property investment summary in paper form.

The real estate sponsor 200 advertises to commercial real estate investors, real estate brokers, and real estate investment companies the opportunity to acquire undivided tenant-in-common interests in the property. Real estate brokers and companies can in turn advertise to other members of the public. The property can be advertised to have 1031 tax deferment benefits offered to qualifying like-kind-exchange investors and that, for example, can produce 6-8% first-year cash-on-cash returns.

The prospective investor can be furnished with information concerning the physical condition of the property, the terms of any leases of all or any portion of the property, the terms of a proposed Property Management Agreement, Asset Management Agreement, Tenant-In-Common Agreement, Call Agreement and operational performance of the property.

Further advertisement information can include data relating to the terms of any mortgage loan encumbering the property. This information can be comparable to that normally received by a prospective purchaser of an undivided interest in a similar commercial property.

The offering of tenant-in-common interests can include print advertisements of a nature typically published in connection with the sale of commercial real estate. All print advertisements can comply in all respects with the laws and regulations applicable to the offering of commercial real estate in the jurisdictions in which tenant-in-common interests can be offered.

In addition, third party due diligence reports, including environmental assessment reports and other physical condition report, can be prepared by lender-approved third party contractors and are provided to the prospective investor. Environmental assessment reports and other physical condition report can also be provided by the real estate sponsor 200. In one embodiment, advertisement and due diligence reports are provided on a CD-ROM along with a tenant-in-common documentation binder.

At process block 324, the potential investor commits to purchase a tenant-in-common interest by submitting earnest money that can be put in escrow. Upon committing to purchase the tenant-in-common interest, the potential investor becomes an investor 210. In one embodiment, an accommodator controls the funds of the investor 210 and wires the funds to the real estate sponsor 200. In another embodiment, the potential investor can log into a secure website 103 supported by sponsor server 100 and, using an electronic signature, commit to purchase a property. The potential investor can furnish a required down payment through any of the available on-line payment methods.

In one embodiment, when an investor 210 purchases tenant-in-common interest, the investor 210 executes a protective election set forth in a tenant in common agreement stating that the investor 210 can be excluded from the provisions of Subchapter K (dealing with partnerships) of the Internal Revenue Code. In addition to the fact that most investors 210 are expected to obtain their purchase funds directly from previously owned real estate, each investor 210 must also represent that the investor 210 has substantial prior experience in owning and operating developed real estate and is aware of, is capable of exercising, and intends to exercise, his control rights on the tenancy-in-common. In one approach, the investor 210 can be required to provide detailed information concerning his experience in real estate investment. As a tenant in common of the property, the investor 210 is provided information so that the investor 210: (i) understands that the tenants in common can be expected to actively manage the property through their supervision and involvement with the property and asset managers, (ii) has the knowledge and experience to be actively involved in such management of the property and (iii) expects to be involved in such management and control of the property.

In one embodiment, each investor 210 can hold title to the tenant-in-common interest in the property through a newly formed single member Delaware limited liability company. The real estate sponsor 200 can also invest funds and retain tenant-in-common interest through a real estate sponsor affiliate which can be a tenant-in-common of each investor 210.

In one embodiment, the real estate sponsor 200 can use the proceeds from the sale of the tenant-in-common interest to repay the preferred loan, to pay expenses associated with the offering and to establish reserves. The proceeds from the sale of the tenant-in-common interests can also be sufficient to pay real estate sponsor 200 and its affiliates at least one fee for carrying out the transaction. Fees that the real estate sponsor can receive include a loan brokerage commission (e.g. 1.5%-2%) of the principal amount of the mortgage payable to real estate sponsor 200 at closing of the mortgage loan for arranging the mortgage loan, a fee (e.g. 4.5%-5.5%) of the purchase price payable to real estate sponsor 200 at closing of each sale of a tenant-in-common interest, and a deferred fee (e.g. 2%) of the purchase price, payable to real estate sponsor 200 upon the first to occur of (a) the sale of the entire property, (b) sale of a tenant-in-common interest by a purchaser (on a pro rata basis) or (c) a number or years after the initial closing date (the maturity date of the mortgage loan). In another embodiment, the real estate sponsor 200 does not receive any of the fees, but instead designates an affiliate of the real estate sponsor 200 to receive some or all of the fees.

The real estate sponsor 200 is not required to perform any services on behalf of the investor 210 after completion of the offering of tenant-in-common interests. As such, the real estate sponsor 200 earns the deferred fee payment at closing.

At process block 326, the real estate sponsor 200 can contribute to the property equity by purchasing one or more tenant-in-common interests. The real estate sponsor 200 can invest in the property discretionarily in order to make the investment more attractive to investors 210. Thus, any tenant-in-common interests not acquired by other investor 210 by the end of the offering period can be acquired by the real estate sponsor 200 with capital raised from private investors and from real estate sponsor 200. This provides investors 210 with an added sense of security because the real estate sponsor 200 funds a percentage of the final cash equity of the property and stands side-by-side with the investor 210 as an at-risk co-investor. In one embodiment, the real estate sponsor 210 can create an affiliate business entity that owns the investment in the property.

At process block 328, the investors 210 can vote or select the asset manager 212 and property manager 214 of their liking. The asset manager 412 can be selected by a vote of the first round of investors (and not by real estate sponsor exclusively), and this selection can be approved by all of the investors 210 as tenant-in-common interests are purchased. Likewise, the property manager 214 is selected by the first round of investors 210. In one embodiment, the first round of investors 210 represents the investors that have committed to purchase the tenant-in-common interest within ten days of the launch of the property investment.

In one embodiment, each investor 210 can log in secure website 103 provided by the real estate sponsor 200 and have access to profile information for each asset manager 212. The investor 210 can then make a selection and submit it through the secure website 103 to the sponsor server 100. Once all selections by the investors 210 have been collected, the sponsor server 100 can provide the results indicating the asset manager 212 elected by the majority of investors 210.

At process block 330, and prior to the close of escrow, administrative control of the property is transferred to the property manager 214. Before closing, the real estate sponsor 200 ceases to exert any control over the property, and within a predetermined number of days (e.g. five), all investors 210 unanimously vote to either retain the current property manager 214 or to select a new property manager.

Finally, at process block 334 the real estate sponsor 200 and the investors 210 close escrow. The real estate sponsor 200 and the investors 210 close the loan and the property simultaneously. Thus, the mezzanine loan as well as the investor 210 proceeds is used to close the loan. The property can be encumbered by a deed of trust in favor of a lender 204. As such, each investor 210 who acquires a tenant-in-common interest in the property can be obliged to assume, or take his interest subject to, his proportionate share of such loan obligations. Thus, each investor 210 can acquire their tenant-in-common interests subject to the mortgage loan and the existing tenant leases relating to the property.

FIG. 3B illustrates flow diagram of the establishing of a real estate tenant-in-common investment structure where the real estate sponsor 200 secures the investment property. At process block 300 the real estate sponsor 200 negotiates the price and locks-in the property at its own expense before any potential investor is identified. In one approach, the real estate sponsor 200 makes an advance deposit (e.g. 24%). In another approach, the real estate sponsor 200 locks-in the price by signing a contract.

In one embodiment, the real estate sponsor 200 simultaneously negotiates interest rates, payment premiums, and loan structure in general with the lender. The real estate sponsor 200 acts as a cosigner to the loan and enters into an agreement with the lender that other cosigners can join. Thus, the real estate sponsor 200 becomes a co-investor. After the lender 204 approves the investors 210, the investors 210 can enter into a non-recourse loan with joint and several liability.

As explained above, at process block 314, the real estate sponsor 200 establishes asset manager candidates, and at process block 316, the real estate sponsor 200 establishes property manager candidates. In addition, at process block 320 the property investment is advertised to potential investors.

At process block 322, the real estate sponsor 200 enters into a contract with a prospective investor where the prospective investor commits to purchase a tenant-in-common interest in the property. The prospective investor receives information regarding the tenant-in-common investment structure, the property, as well as appropriate loan information, interest rates, etc.

The prospective investor can log into a secured site maintained by the sponsor web server 100 and inquire about all the information related to the loan, the property, other existing cosigners, etc.

After the property manager 214 and the asset manager 212 are selected, the real estate sponsor 200 transfers property management control of the real estate property to the property manager 212. In another embodiment, the investors 210 corroborate the selection of the real estate sponsor 200.

Finally, at process block 332 the lender and each of the investors 210 close escrow (e.g. pass title to the investors 210). In one embodiment, the real estate sponsor 200 can acquire the property immediately prior to the sale of a tenant-in-common interest to the investor 210. In another embodiment, the real estate sponsor 200 can acquire the property in advance, and long before the sale of the tenant-in-common interest to the investor 210. The sale of the tenant-in-common interests can be consummated pursuant to the terms of separate purchase agreements between the real estate sponsor 200 and each investor 210.

In one embodiment, a first round of closings is carried out for the real property sponsor 210 and for the investors 210 that have committed to purchasing the property within a predetermined amount of time. Subsequent rounds of closings are done for investors 210 that join in later. In one example, a first closing of the sale of tenant-in-common interest can occur after the real estate sponsor 200 has accepted from investors 210 not affiliated with real estate sponsor 200 purchase agreements for over fifty-percent of the tenant-in-common interests. In a further example, the offering of tenant-in-common interests can continue following the initial closing date until the earlier of the date all of the tenant-in-common interests have been sold, ninety days after the initial closing date; or one-hundred and eighty days after the initial offer of tenant-in-common interests. After closing, and after the title has been transferred to the investors 210, each of the investors 210 can be a tenant in common of the property.

Control Divestment

After closing, the real estate sponsor 200 ceases to exert any property management control on the property. If the real estate sponsor 200 elected to invest in the property, the real estate sponsor 200 can have control over the property only to the extent that the real estate sponsor 200 is another investor in the property. In other words, the real estate sponsor 200 can be treated like one of the investors (i.e. tenants in common) with the same privileges and obligations.

The real estate sponsor 200 does not participate in any of the benefits or liabilities (including net income, or net loss, or cash flow distributions, or any gain or loss upon disposition of the property) from the property, other than those fees real estate sponsor or its affiliates earn in connection with the sale of tenant-in-common interests in the property. As such, the real estate sponsor 200 relinquishes any property management control over the real estate property. The relinquishment of property management control frees the real estate sponsor 200 from any managerial responsibility over the property. This allows the real estate sponsor 200 to be able to purchase a tenant-in-common interest without the implications of a potential conflict of interests that would otherwise ramify from being a tenant-in-common as well as being a property manager. A property manager must act in favor of the best interest of all tenants-in-common. A conflict may arise if the property manager makes a decision that benefits his or her interest as a tenant-in-common. Therefore, where the property manager is a neutral third party, no conflicts arise. The real estate sponsor 200 prevents such conflict by stepping away from any control on the real estate property, and transferring such that the real estate sponsor does not become an asset manager, property manager, administrator, trustee, or any other position of control over the real estate property.

In one embodiment, the real estate sponsor 200 can participate in those benefits and liabilities derived from the real estate sponsor's interest and equity investment that the real estate sponsor 200 has as a tenant-in-common co-owner. As such, the real estate sponsor does not earn any fees with respect to the property after the closing of the sale of tenant-in-common interests in the property to the other investors.

If investors 210 engage an unrelated third-party property manager to operate the property, the investors 210 cannot be involved in daily operations. However, the investors 210 can still control the property, including the sale of the property. At any time, any investor can terminate the engagement with the property manager 214, subject to lender approval.

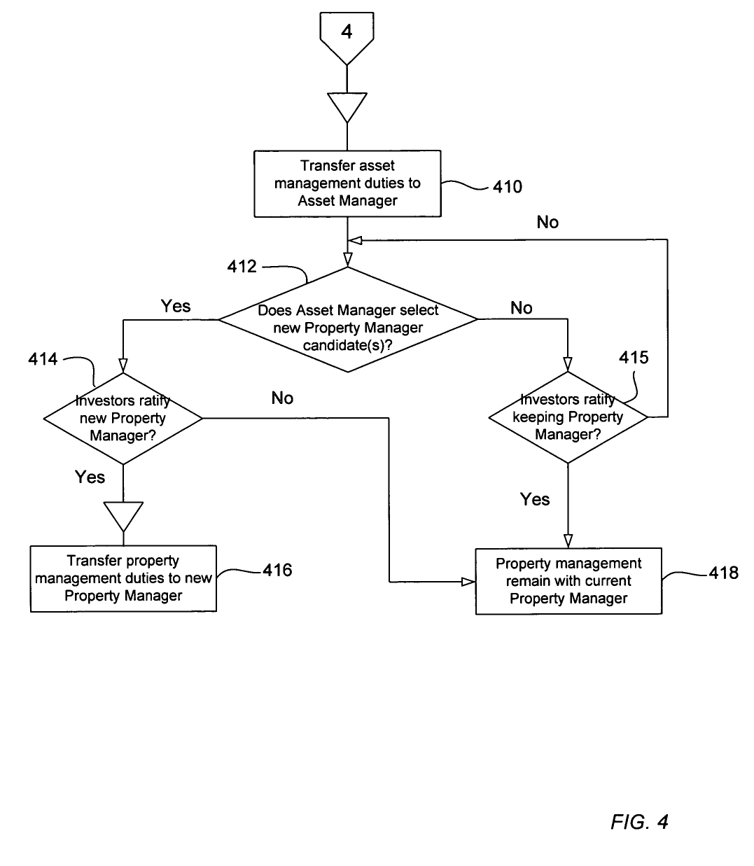

FIG. 4 illustrates flow diagram of the post-closing transactions. In one embodiment, an asset manager 212, unrelated to the real estate sponsor 200, can also be engaged by the investors 210. In addition, any investor can terminate the asset management engagement, depending on circumstances and contract provisions (without cause on an annual basis, at any time for cause, subject to approval of the lender, etc).

In one embodiment, at process block 410, the asset management duties are transferred to the asset manager 212. At decision block 412, the asset manager 212 can choose whether to replace the current property manager 214. If the asset manager recommends that the current property manager 214 be kept, the investors 210 can follow such recommendation and ratify at decision block 415. If the investors 210 decide to keep the current program manager 214, the current manager 214 will remain the same at process block 418 in which case no replacement is necessary. If the asset manager 212 suggests a new property manager 214, the investors can ratify the suggestion of the asset manager 212 at decision block 414. If the investors do not ratify the suggestion of the asset manager 212, the current property manager remains as indicated in process block 418. Finally, the duties of property management are transferred to the elected property manager 214 at process block 416. The performance of the property manager 214 can be monitored by the asset manager 212.

On an individual level, each investor 210 has the right to sell or encumber his tenant-in-common interest in the property, subject to the terms and conditions of any mortgage debt encumbering the property. In addition, each investor can have right to cause a judicial partition or sale of the property depending on lender 204 restrictions. In one embodiment, the investors can enter into an agreement under which the other investors would have the right to purchase the interest of such investor at the then fair market value prior to any partition or sale being completed.

Each purchaser is required to be actively involved in decision-making concerning the property. Interests can be sold only to individuals who have substantial experience with real estate investment. Furthermore, individuals can also be required to be approved by the lender 204 depending on the terms of the loan. The tenants in common can meet (either in person or telephonically) on a regular basis.

In addition to the property manager 214 and the asset manager 212, other third party advisors may be annually hired to better manage and exploit the property. None of these advisor third parties is contemplated to be related to the real estate sponsor 200. In one embodiment, an investment advisory firm can be hired. The investment advisory firm can be independent and experienced real estate advisor operating under an annual contract by the investors 210. The investment advisory firm reports periodically to the investors 210, and can provide give advice on a host of issues such as lease rates, market conditions, when to sell, etc.

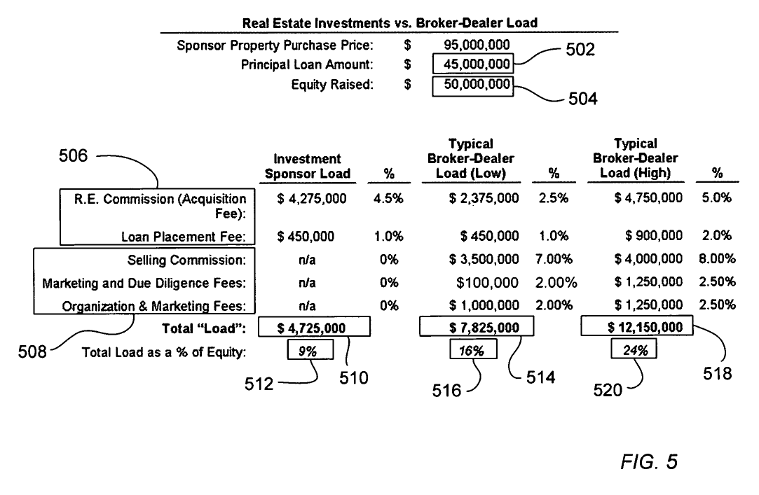

FIG. 5 illustrates comparison chart among a real estate sponsor equity load, and a securities-type broker equity load. By way of background, as prospective investors 210 compare the overall costs of looking at tenancy-in-common transactions as either securities or real estate, commission loads are generally significantly lower for a tenancy-in-common transaction as a real estate brokerage product as compared to an equivalent commissioned securities product. Thus, the purchase price of a tenancy-in-common interest qualified as exclusively as a real estate interest can be lower than the same tenancy-in-common interest if offered as a security. Transferring to third parties all management control of the property after closing, and permitting some control of prospective investors prior to closing, allows the real estate sponsor 200 to offer the tenancy-in-common interest as a real estate interest. As such, a real estate sponsor 200 that offers tenancy-in-common interest as real estate can offer a purchase price of the tenancy-in-common interest lower than what any securities broker can offer. Therefore, given the same underlying property asset, the investor 210 that purchases a real estate tenancy-in-common interest will acquire the property at a lower price and have higher returns on investment.

A computer system can be used to calculate the tenancy-in-common interest price taking into account the interest of the lender, the equity amount, etc. In one embodiment, the sponsor server 100 is configured with software to calculate percentages of loan amount 502 and equity amount 504 as they relate to each investor 210.

For example, the sponsor server 100 can be configured to calculate sponsor fees 506 such as the fees to sponsor and affiliates as well as the loan brokerage commission based on the loan amount 502. Thus, the sponsor server 100 can produce calculated percentages of sponsor fees 506 and display a total load amount 510 and the equity percentage 512 on the website 103.

In another embodiment, the sponsor server 100 can be further configured to calculate the load amount that each investor 210 can have to pay as part of the tenant-in-common interest. Such load amount can be dynamically updated and posted on the website 103 and available as investment information before investors commit to purchase a tenant-in-common interest in the property.

The sponsor server 100 does not have to be configured, however, to calculate the broker commission fees 508 if the tenant-in-common interests are not being sold as securities by the real estate sponsor 200. Commission fees are appropriate where the tenant-in-common interests are being sold as securities. Then broker commission fees 508 such as selling commission, marketing and due diligence fees, and organization and marketing fees, are also calculated and applied. As a result, a typical low total load 514 and the low load equity percentage 514 can be higher than the loads for a real estate sponsor load where a non-security interest is calculated. Similarly, the typical high total load 518 and the high load equity percentage 520 can be even higher rates that can ultimately be charged to the investor 210.

In sum, the sponsor server 100 can be configured to produce a concrete result as to the purchase price of the tenant-in-common interest, the total final load on the equity of the property, the final load on the equity of each tenant-in-common interest, among others. Where tenant-in-common interests are sold and the real estate sponsor 200 yields all control to the investors 210, the real estate sponsor 210 can provide the investors with the lowest commission rate and the highest amount of control over the tenant-in-common interest.

Of course, the calculations, comparisons, record keeping, data manipulation, communications, etc. described herein as being performed by an electronic data processor, computer, and/or Internet, may also be performed manually such as by using hand calculations, paper records, and telephonic or written communications, either partially or in total.

Although certain illustrative embodiments and methods have been disclosed herein, it can be apparent form the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

We claim:

1. A data processing method of selling tenant-in-common interests as non-security investments by a real estate sponsor, comprising:
purchasing a real estate property at a purchase price;
calculating an investment price of a tenant-in-common interest in the real estate property, the investment price being calculated by a computer system utilizing the purchase price and a sponsoring fee;
soliciting at least one offer to purchase a tenant-in-common interest in the real estate property at least through a computer network;
receiving at least one offer to purchase a tenant-in-common interest in the real estate property;
accepting an offer to purchase a tenant-in-common interest from at least one investor;
yielding day-to-day property management to a third party, such that the real estate sponsor relinquishes all right to exercise property management control, the third party being elected by the at least one investor; and
closing the sale of the property with the at least one investor.

2. The data processing method of claim 1, wherein the real estate sponsor is not the third party, such that the real estate sponsor does not exercise property management control after the sale of the property has being closed.

3. The data processing method of claim 1, wherein the at least one offer is solicited based on the calculated investment price.

4. The data processing method of claim 1, wherein the sponsoring fee comprises a loan brokerage commission.

5. The data processing method of claim 1, wherein the calculated investment price does not take into account any securities brokerage fees.

6. The data processing method of claim 1, wherein the real estate sponsor collects the sponsoring fee from proceeds of the sale of the properties.

7. The data processing method of claim 1, wherein the real estate sponsor secures a mortgage loan and a preferred loan, the preferred loan being paid with proceeds of tenant-in-common interest sale to the at least one investor.

8. The data processing method of claim 1, further comprising storing investor data related to investors that submitted offers, the investor data being stored in an investor database.

9. The data processing method of claim 7, wherein the investor database resides in a mass storage server.

10. The data processing method of claim 7, wherein yielding day-to-day property management to a third party includes transferring management privileges of the investor database from the real estate sponsor to the third party.

11. The data processing method of claim 1, wherein the third party is an asset manager, property manager, administrator, trustee.

12. The data processing method of claim 1, wherein the real estate sponsor is an investor.

13. The data processing method of claim 1, wherein the third party is elected by vote of the at least one investor.

14. The data processing method of claim 1, wherein soliciting at least one offer to purchase a tenant-in-common interest includes requiring to provide statements of prior experience in owning and operating developed real estate and of willingness to exercises control of ownership rights on the tenancy-in-common interest.

15. The data processing method of claim 1, wherein soliciting at least one offer to purchase a tenant-in-common interest includes advertising on a public medium, including price, interest rates, physical condition of the property, property management agreement, and asset management agreement.

16. The data processing method of claim 1, wherein a real estate broker is utilized to advertise the tenant-in-common interests.

17. The data processing method of claim 1, further comprising purchasing a tenant-in-common interest in the real estate property.

18. The data processing method of claim 1, wherein the period lapsed between purchasing the real estate property and closing the sale of the real estate property is less than forty-five days such that the real estate sponsor can benefit from tax deferments.

19. The data processing method of claim 1, wherein the computer system is connected to the computer network, and the computer system is configured as a web server that displays the calculated investment price on a website.

20. The data processing method of claim 1, wherein the at least one investor takes the tenant-in-common interests subject to a mortgage on the property.

21. The data processing method of claim 1, wherein an offer can be made by submitting investor information and offer information to a server administrated by the real estate sponsor.

22. The data processing method of claim 1, wherein the third party is a property manager, the property manager being able to postulate himself for election by the at least one investor through a real estate sponsor website.

23. The data processing method of claim 1, further comprising:
transferring asset management duties to an asset manager;
wherein the asset manager recommends whether to retain the same third party to conduct day-to-day property management or to elect a another party in order to conduct day-to-day property management; and
wherein the at least one investor can choose between ratifying the election of the asset manager and declining the election of the asset manager.

24. The data processing method of claim 1, further comprising:
receiving a second offer to purchase a tenant-in-common interest in the real estate property;
accepting the second offer of at least one investor; and
closing the sale of the property with the at least one investor.

25. A method of selling tenant-in-common interests as non-security investments by a real estate sponsor, comprising:
purchasing a real estate property at a purchase price;
calculating an investment price of a tenant-in-common interest in the real estate property, the investment price being calculated based on the purchase price and a sponsoring fee;
soliciting at least one offer to purchase a tenant-in-common interest in the real estate property;
receiving at least one offer to purchase a tenant-in-common interest in the real estate property;
accepting an offer to purchase a tenant-in-common interest from at least one investor;
yielding day-to-day property management to a third party, such that the real estate sponsor relinquishes all right to exercise property management control, the third party being elected by the at least one investor; and
closing the sale of the property with the at least one investor.

26. A method of selling tenant-in-common interests as non-security investments by a real estate sponsor, comprising:
securing a real estate property at a purchase price by committing to purchase the real estate property and obtaining a loan from a lender;
calculating the investment price based on the purchase price and a sponsoring fee;
soliciting at least one offer to purchase a tenant-in-common interest in the real estate property;
receiving at least one offer to purchase a tenant-in-common interest in the real estate property;
accepting an offer to purchase a tenant-in-common interest from at least one investor;
yielding day-to-day property management to a third party, the third party being elected by the at least one investor; and
closing the sale of the property between the lender and the at least one investor.

27. A method of selling tenant-in-common interests as non-security investments by a real estate sponsor, comprising:
offering at least one tenant-in-common interest in a real estate property to the public;
receiving an acceptance from at least one investor;
yielding day-to-day property management to a third party, the third party being elected by the at least one investor; and
closing the sale of the property between the real estate sponsor and the at least one investor.
